(19) United States
(12) Patent Application Publication
(10) Pub. No.: US 2024/0394642 A1
(43) Pub. Date: Nov. 28, 2024

(54) WORK MANAGEMENT SYSTEM, WORK MANAGEMENT APPARATUS, WORK MANAGEMENT METHOD, AND NON-TRANSITORY COMPUTER READABLE MEDIUM

(71) Applicant: NEC Corporation, Minato-ku, Tokyo (JP)

(72) Inventors: Hidekazu NAGAOKA, Tokyo (JP); Hiromi MUTO, Tokyo (JP); Hideyuki MIYOSHI, Tokyo (JP)

(73) Assignee: NEC Corporation, Minato-ku, Tokyo (JP)

(21) Appl. No.: 18/716,975

(22) PCT Filed: Dec. 21, 2021
(86) PCT No.: PCT/JP2021/047157

§ 371 Date: Jun. 6, 2024

(51) Int. Cl. G06Q 10/0639

(52) U.S. Cl. CPC G06Q 10/06398

(57) ABSTRACT

A work management system inputs work data for an area and articles to be managed by a warehouse management system. The work management system makes one or a plurality of 3D sensor to measure a depth of an object so as to include the area in a measurement range at least during a period during which the work data is recorded, and thereby acquires depth data including time. The work management system recognizes a position of an arbitrary person and time at the position from the depth data and generate movement data based on a result of the recognition. The work management system matches, based on both of the data, the arbitrary person with the worker by using the time as a key, and thereby identifies the arbitrary person. The work management system associates both of the data for the identified worker.

### TECHNICAL FIELD

The present disclosure relates to a work management system, a work management apparatus, a work management method, and a program.

### BACKGROUND ART

When articles are to be carried out of a warehouse, a worker may take the articles from shelves in the warehouse, collect them, and then convey them to a predetermined place. The following warehouse management system may be used to manage such conveyance work. This warehouse management system makes it possible to manage conveyance work for each article by sending a notification about each article to be taken out of a shelf to a portable terminal, such as a handy terminal, used by a worker and recording conveyance work thereof.

Patent Literature 1 discloses a picking system including a management apparatus, a storage box in which a picked article is stored, display means, and a portable terminal apparatus, in which the management apparatus and the portable terminal apparatus are configured so that they can communicate with each other through a communication channel. The management apparatus stores identification information of a destination to which an article is delivered and picking data of the article in association with each other, and issues a code information list indicating at least the identification information of the destination of the delivery. The display means displays code information indicating identification information that is attached to the storage box in which the article is stored and indicates identification information of the storage box. The portable terminal apparatus includes a code reading unit that reads the code information, and a control unit. The control unit performs a process for reading the code information indicating the identification information of the storage box and the code information indicating the identification information of the destination of the delivery in the list by using the code reading unit, associating the read identification information of the storage box with the identification information of the destination of the delivery, and transmitting them to the management apparatus. The management apparatus includes a control unit, and when the identification information of the storage box and the identification information of the destination of the delivery are received from the portable terminal apparatus, the control unit performs a process for transmitting the picking data associated with the identification information of the destination of the delivery to the portable terminal apparatus. The control unit of the portable terminal apparatus displays an instruction to pick the article on a display unit of the portable terminal apparatus based on the picking data received from the management apparatus,

### CITATION LIST

### Patent Literature

Patent Literature 1: Japanese Unexamined Patent Application Publication No. 2013-209206

### SUMMARY OF INVENTION

As described above, in the warehouse management system, it is possible to recognize a work content and a work time of a worker for each article, and thereby to manage collecting work for each article. However, there is problem that it is not possible to recognize whether the worker is efficiently performing the collecting work. In particular, in a warehouse, there may be a worker who is not yet familiar with his/her work. In such a case, there may be an occasion in which such a worker asks other workers about the location of shelves, or workers talk with each other about matters not related to their work. Therefore, it is desirable to solve the above-described problem. Note that the technology disclosed in Patent Literature 1 is not one by which the above-described problem can be solved. As described above, it is desired to develop a system that makes it possible to recognize not only a work content and a work time of a worker for an article but also whether the worker is efficiently performing collecting work.

The present disclosure has been made to solve the above-described problem, and an object thereof is to provide a work management system and the like that make it possible to recognize, for work for collecting articles in a warehouse, efficiency or quantity of the work performed by a worker.

A work management system according to a first aspect of the present disclosure includes: an input unit configured to input work data for an area and articles to be managed by a warehouse management system, the work data being data in which, for work for taking out the articles from, among shelves installed in the area, a shelf designated by the warehouse management system, collecting them, and then conveying them to a predetermined position in the area, a work content and a work time for each worker are recorded; one or a plurality of 3D sensors configured to measure a depth of an object so as to include the area in a measurement range at least during a period during which the work data is recorded, and thereby acquire depth data including time; a movement data generation unit configured to recognize a position of an arbitrary person and time at the position from the depth data and generate movement data based on a result of the recognition; an identification unit configured to match, based on the work data input by the input unit and the movement data generated by the movement data generation unit, the arbitrary person indicated by the movement data with the worker by using the time as a key, and thereby identify the arbitrary person; and an association unit configured to associate the movement data with the work data with respect to the worker identified by the identification unit.

A work management apparatus according to a second aspect of the present disclosure includes: an input unit configured to input work data for an area and articles to be managed by a warehouse management system, the work data being data in which, for work for taking out the articles from, among shelves installed in the area, a shelf designated by the warehouse management system, collecting them, and then conveying them to a predetermined position in the area, a work content and a work time for each worker are recorded; one or a plurality of 3D sensors configured to measure a depth of an object so as to include the area in a measurement range at least during a period during which the work data is recorded, and thereby acquire depth data including time; a movement data generation unit configured to recognize a position of an arbitrary person and time at the position from the depth data and generate movement data based on a result of the recognition; an identification unit configured to match, based on the work data input by the input unit and the movement data generated by the movement data generation unit, the arbitrary person indicated by the movement data with the worker by using the time as a key, and thereby identify the arbitrary person; and an association unit configured to associate the movement data with the work data with respect to the worker identified by the identification unit.

A work management method according to a third aspect of the present disclosure includes: inputting work data for an area and articles to be managed by a warehouse management system, the work data being data in which, for work for taking out the articles from, among shelves installed in the area, a shelf designated by the warehouse management system, collecting them, and then conveying them to a predetermined position in the area, a work content and a work time for each worker are recorded; measuring a depth of an object so as to include the area in a measurement range at least during a period during which the work data is recorded, and thereby acquiring depth data including time; recognizing a position of an arbitrary person and time at the position from the depth data and generating movement data based on a result of the recognition; matching, based on the input work data and the generated movement data, the arbitrary person indicated by the movement data with the worker by using the time as a key, and thereby identifying the arbitrary person; and associating the movement data with the work data with respect to the identified worker.

A program according to a fourth aspect of the present disclosure causes a computer to perform a work management process including: inputting work data for an area and articles to be managed by a warehouse management system, the work data being data in which, for work for taking out the articles from, among shelves installed in the area, a shelf designated by the warehouse management system, collecting them, and then conveying them to a predetermined position in the area, a work content and a work time for each worker are recorded; measuring a depth of an object so as to include the area in a measurement range at least during a period during which the work data is recorded, and thereby acquiring depth data including time; recognizing a position of an arbitrary person and time at the position from the depth data and generating movement data based on a result of the recognition; matching, based on the input work data and the generated movement data, the arbitrary person indicated by the movement data with the worker by using the time as a key, and thereby identifying the arbitrary person; and associating the movement data with the work data with respect to the identified worker.

According to the present disclosure, it is possible to provide a work management system, a work management apparatus, a work management method, a program, and the like that make it possible to recognize, for work for collecting articles in a warehouse, efficiency or quantity of the work performed by a worker.

### BRIEF DESCRIPTION OF DRAWINGS

FIG. 1 is a block diagram showing an example of a configuration of a work management system according to a first example embodiment;

FIG. 2 is a flow diagram for explaining an example of processes performed in the work management system according to the first example embodiment;

FIG. 3 is a block diagram showing an example of a configuration of a system including a work management system according to a second example embodiment;

FIG. 4 is a schematic diagram showing an example of a series of picking operations performed by a worker in the system shown in FIG. 3;

FIG. 5 is a schematic diagram showing an example of a moving route along which a worker moves during a series of picking operations performed by the worker in the system shown in FIG. 3;

FIG. 6 is a schematic diagram for explaining an example of work data acquired in the system shown in FIG. 3;

FIG. 7 shows an example of depth data measured by a 3D sensor of the work management system shown in FIG. 3;

FIG. 8 is a schematic diagram showing an example of movement data generated in the work management system shown in FIG. 3;

FIG. 9 is a schematic diagram showing an example of matching between movement data and work data in the work management system shown in FIG. 3;

FIG. 10 is a schematic diagram showing another example of matching between movement data and work data in the work management system shown in FIG. 3;

FIG. 11 is a schematic diagram showing an example of a process for aligning coordinates of movement data and those of work data in the work management system shown in FIG. 3; and

FIG. 12 shows an example of a hardware configuration of an apparatus.

### DESCRIPTION OF EMBODIMENTS

An example embodiment will be described hereinafter with reference to the drawings. Note that in the example embodiment, the same or equivalent elements are assigned the same reference numerals (or symbols), and redundant descriptions thereof may be omitted.

### First Example Embodiment

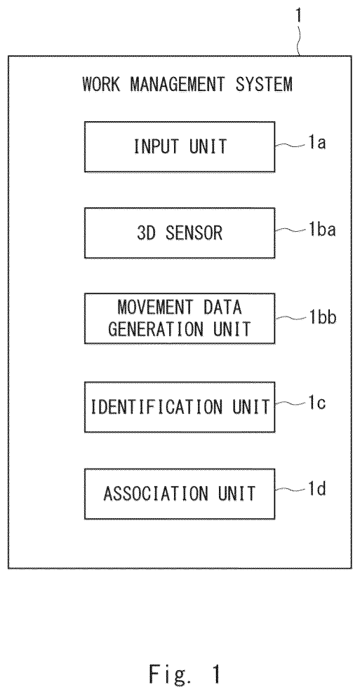

FIG. 1 is a block diagram showing an example of a configuration of a work management system according to a first example embodiment.

As shown in FIG. 1, a work management system 1 according to this example embodiment may include an input unit 1a, one or a plurality of 3D sensors 1ba, a movement data generation unit 1bb, an identification unit 1c, and an association unit 1d.

The input unit 1a inputs the following work data for an area and articles to be managed in a warehouse management system. That is, the aforementioned work data is data in which, for work for taking out articles from, among shelves installed in the aforementioned area, a shelf designated by the warehouse management system, collecting them, and then conveying them to a predetermined position in the area, a work content and a work time for each worker are recorded. This work is also referred to as picking work. Note that the predetermined position at the destination of the conveyance (hereinafter also referred to as the conveyance destination) may be changed for each article.

The above-described warehouse management system is a system capable of recording such work data. The warehouse management system is a system for managing articles temporarily stored in a warehouse, and can be used, for example, as an inventory management system for managing the inventory of commodities or a system for managing the collection and delivery of objects to be delivered at a distribution base or the like. Note that any method can be used as the method for managing articles in the warehouse management system, as long as such work data can be generated.

For example, a worker has a portable terminal such as a handy terminal or a smartphone, and reads a bar code attached to an article, and then reads contents recorded on an IC (Integrated Circuit) chip attached to the article through short-range wireless communication. In this way, it is possible to record how the article has been handled on the portable terminal, and to transfer this recording to a server apparatus provided in the warehouse management system. Further, this server apparatus can transmit information indicating the place where an article to be handled is located to the portable terminal of the worker, and thereby enables the worker to perform work therefor.

The work management system 1 includes such a warehouse management system or can be connected to such a warehouse management system. In the latter case, the input unit 1a can input work data from the warehouse management system through communication.

The 3D sensor 1ba measures the depth (distance) of an object in such a manner that the above-described area is included in the measurement range at least in a period during which work data is recorded, and thereby acquires depth data including time. One or a plurality of 3D sensors 1ba may be installed, for example, at a position(s) where it (they) can perform measurement from above the aforementioned area, such as on a ceiling. However, the 3D sensor 1ba may be installed at any place.

The number of 3D sensors 1ba is not limited to any particular number. However, since there is no need to recognize faces, the number of 3D sensors 1ba can be reduced compared to the case where an appropriate number of devices that need to recognize faces are installed for the size of a warehouse. Any method can be used as the distance measurement method used in the 3D sensor. Further, a 3D sensor that measures distances in all directions can be used as the 3D sensor 1ba, but it is sufficient if the area of the warehouse can be covered by one or a plurality of such sensors.

Further, the movement data generation unit 1bb recognizes the position of an arbitrary person and time at that position from the depth data acquired by the one or plurality of installed 3D sensors 1ba, and generates movement data based on the result of the recognition. This movement data can be data in which time is attached to a position, and the time can be added as a time stamp. Note that the movement data generation unit 1bb can distinguish a human being from a non-human object by determining its external shape and/or movement, and the like, and can track an arbitrary person in a time-series manner by, for example, obtaining a difference from the immediately preceding recognition result. The movement data can be data in which the movement of the aforementioned arbitrary person is recorded by recording his/her position and time at the position.

The identification unit 1c matches, based on the work data input by the input unit 1a and the movement data generated by the movement data generation unit 1bb, the above-described arbitrary person indicated by the movement data with the worker by using the time as a key, and thereby identifies the above-described arbitrary person. Note that the position of the worker at the time when he/she came to the position at the conveyance origin or the conveyance destination is included in the work data, and the position of the above-described arbitrary person is included in the movement data together with the corresponding time. Therefore, the identification unit 1c can perform matching based on these positions by using the time as a key. In other words, the identification unit 1c can match the above-described arbitrary person with the worker by using the work content indicated by the work data and the position indicated by the movement data and using the time as a key. Note that the matching is not performed between data of different days.

The association unit 1d associates (links) the movement data with the work data with respect to the worker identified by the identification unit 1c. Any method can be used as the associating method. The work data of a worker may be incorporated into the movement data of the worker, or the movement data of a worker may be incorporated into the work data of the worker. Further, the association unit 1d may separately generate, by association, work movement data in which work and movement of the worker is recorded.

Further, movement data, and information indicating association between movement data and work data can be stored in the work management system 1, and the association unit 1d may include such a storage device. Work data input by the input unit 1a may also be stored in this storage device, but work data may be stored only in the warehouse management system as long as it can be referred to from the work management system 1. Note that the movement data may also be stored in a storage device provided in the movement data generation unit 1bb.

The work management system 1 may include a control unit (not shown), and this control unit may include the above-described input unit 1a, the movement data generation unit 1bb, the identification unit 1c, and the association unit 1d.

This control unit may be implemented by, for example, a CPU (Central Processing Unit), a working memory, and a nonvolatile storage device storing a program(s). This program may be a program for causing the CPU to perform processing of the input unit 1a, the movement data generation unit 1bb, the identification unit 1c, and the association unit 1d. Further, a storage device provided in this control unit can also be used as a storage device for storing various data such as movement data and information indicating association.

Further, the work management system 1 can be configured as a single work management apparatus including a 3D sensor(s), or as a plurality of apparatuses over which functions are distributed. In the latter case, each apparatus may include a control unit, a communication unit, and a storage unit as required, and these plurality of apparatuses may be connected as required through wireless or wired communication, so that the functions of the work management system 1 are implemented by their cooperation.

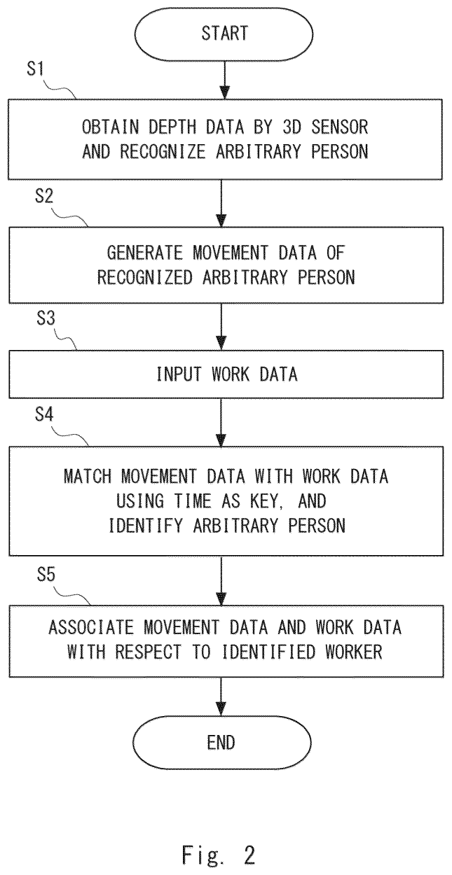

Next, an example of processes performed by the work management system 1 will be described with reference to FIG. 2. FIG. 2 is a flow diagram for explaining an example of processes performed in the work management system 1.

Firstly, the work management system 1 obtains depth data by the 3D sensor(s), recognizes an arbitrary person (Step S1), and generates movement data of the recognized arbitrary person (Step S2). When the movement data are prepared, the work management system 1 inputs work data (Step S3). Note that the order of the steps S2 and S3 may be arbitrarily determined. That is, it is possible to perform processes for generating movement data and inputting work data simultaneously in parallel or perform them successively.

Next, the work management system 1 matches, based on the work data and the movement data, the above-described arbitrary person indicated by the movement data with the worker by using the time as a key, and thereby identifies the above-described arbitrary person (Step S4). Next, the work management system 1 associates the movement data with the work data with respect to the identified worker (Step S5), and finishes the series of processes.

As described above, in this example embodiment, work data and movement data can be associated with each other for a worker, thus making it possible to view and/or analyze both of these data for the worker. Further, by configuring the 3D sensor(s) 1ba so as to measure a person from above the above-described area, there is no need to install such sensors in many places per unit area.

Therefore, according to this example embodiment, it is possible to recognize efficiency or quantity of work for collecting articles, performed by a worker in a warehouse. Further, it is possible to, by configuring the 3D sensor(s) 1ba so as to perform measurement from above the above-described area, recognize the efficiency or quantity of work without installing a large number of detection devices. Further, a worker does not need to possess, for example, a communication device or a cap with a mark by which his/her position is transmitted to the work management system 1, or the positions of other workers are acquired from the work management system 1 through communication.

Therefore, it is sufficient if a worker performs work while carrying a portable terminal used in the warehouse management system.

### Second Example Embodiment

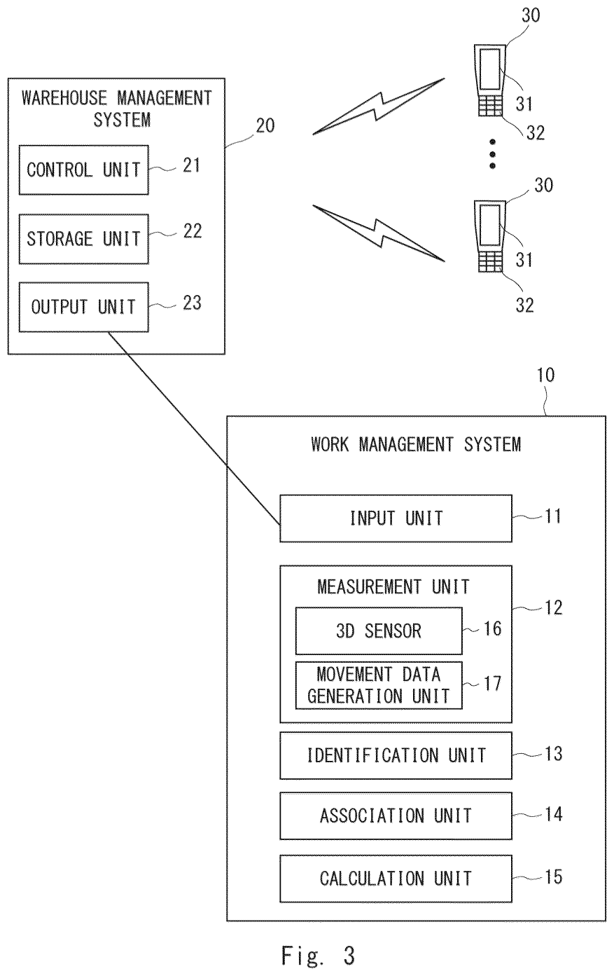

A second example embodiment will be described with reference to FIGS. 3 to 11 with a particular emphasis on differences from the first example embodiment. It should be noted that various examples described in the first example embodiment can be applied thereto. FIG. 3 is a block diagram showing an example of a configuration of a system including a work management system according to the second example embodiment.

A system shown in FIG. 3 (hereinafter referred to as this system) may include a work management system 10 according to this example embodiment, a warehouse management system 20, and a portable terminal 30 used by a worker. Since the portable terminal 30 is a terminal apparatus carried by a worker and is carried by each worker, in general, a plurality of such portable terminals are used in this system.

The work management system 10 is an example of the work management system 1 shown in FIG. 1, and may include an input unit 11, a 3D sensor(s) 16, a movement data generation unit 17, an identification unit 13, and an association unit 14 as examples of the input unit 1a, the 3D sensor(s) 1ba, the movement data generation unit 1bb, the identification unit 1c, and the association unit 1d, respectively. Note that in the following description, the 3D sensor 16 and the movement data generation unit 17 will be collectively referred to as a measurement unit 12. Further, the work management system 10 includes a calculation unit 15 (which will be described later).

The warehouse management system 20 can be formed by a single apparatus or a plurality of distributed apparatuses (e.g., a server apparatus(es)), and may include, for example, a control unit 21, a storage unit 22, and an output unit 23. The control unit 21 is a control unit that controls the whole warehouse management system 20.

The control unit 21 may be implemented by, for example, a CPU, a working memory, and a nonvolatile storage device storing a program(s). This program may be a program for causing the CPU to perform processes necessary for warehouse management, including a process for generating work data. Further, a storage device provided in the control unit 21 can also be used as the storage unit 22. The storage unit 22 is a storage device in which various data for warehouse management, including work data used in the work management system 10, are stored. The output unit 23 is a part that outputs work data voluntarily or in response to a request from the work management system 10, and may include a communication unit.

The portable terminal 30 may include a control unit (not shown) that controls the whole portable terminal, and may include a display unit 31 and operation buttons 32. This control unit may be implemented by, for example, a CPU, a working memory, and a nonvolatile storage device storing a program(s). This program may be a program for causing the CPU to perform processes such as displaying, on the display unit 31, a list of articles to be handled or the like, transmitted from the warehouse management system 20. The processes may include, for example, a process for inputting a conveyance start time and a conveyance end time of an article by the operation buttons 32 and a process for transmitting such input information to the warehouse management system 20. Note that in place of or in addition to the operation buttons 32, the display unit 31 may include a touch sensor by which a user or the like can perform a touch operation.

The input unit 11 inputs (i.e., receives), from the warehouse management system 20, work data in which, for an area and articles to be managed by the warehouse management system 20, a work content and a work time for each worker are recorded for picking work in the area. The input unit 11 may include a communication unit that communicates with the communication unit provided in the output unit 23.

Note that the work data may be data that a worker enters at the conveyance start time and the conveyance end time of an article in the portable terminal 30 carried by the worker. However, the work data is not limited to the above-described data as long as it is data in which a work content and time for each worker are recorded.

In the picking work, a conveyance start point refers to time when the article is taken out, or time when the worker enters information indicating that he/she arrived at a predetermined start position. Further, in this case, the conveyance end time refers to time when the worker arrived at a predetermined position.

The measurement unit 12 performs measurement by using the 3D sensor 16 and generates movement data based on obtained depth data. As described as the 3D sensor 1ba in the above description, the 3D sensor 16 measures the depth (distance) of an object from above the object in such a manner that the above-described area is included in the measurement range at least in a period during which work data is recorded, and thereby acquires depth data including time. As described as the movement data generation unit 1bb in the above description, the movement data generation unit 17 of the measurement unit 12 recognizes the position of an arbitrary person and time at that position from the depth data acquired by the one or plurality of installed 3D sensors 1ba, and generates movement data based on the result of the recognition.

As described as the identification unit 1c in the above description, the identification unit 13 identifies, based on the work data input by the input unit 11 and the movement data generated by the movement data generation unit 17, the above-described arbitrary person indicated by the movement data. This identification is carried out by matching, based on the work data and the movement data, the above-described arbitrary person with the worker by using the time as a key. Further, as described as the association unit 1d in the above description, the association unit 14 associates (links) the movement data with the work data with respect to the worker identified by the identification unit 13.

Then, the calculation unit 15 calculates, based on the movement data and the work data with respect to the worker associated by the association unit 14, an index indicating the efficiency (productivity) or quantity of the work for each worker. Note that the calculated index for each worker can be stored in such a manner that they can be displayed and viewed in the form of a list or the like. The efficiency of work can be, for example, a work content (content of work), the number of articles or the total weight of articles carried by the worker per unit time. Further, the quantity of work can be, for example, the number of articles or the total weight of articles carried by the worker.

However, the efficiency or quantity of work is not limited to the above-described examples, and can be calculated as a value that indicates how much the route deviates from the shortest route. Further, the efficiency of work can be calculated based on the moving distance of the worker expected from the work content and the distance that the worker actually has moved. In general, the efficiency or quantity of work deteriorates or decreases as the moving distance increases, and deteriorates or decreases as a time period during which the worker stays in one place increases.

Therefore, for example, the movement data generation unit 17 can generate, in advance, moving route data indicating a moving route (work route) including times (i.e., including time data) of the above-described arbitrary person as movement data based on the positions of the above-described arbitrary person and times at the positions. Then, the calculation unit 15 can calculate, based on the movement data and the work data associated with the worker, a stay time during which the worker had stayed in an arbitrary position. For example, a time period during which the worker had stayed at a position a predetermined distance away from the conveyance start point or the conveyance end point can be calculated as the stay time. Then, the calculation unit 15 can calculate the above-described index based on the predetermined number of articles, a conveyance time required for the conveyance of these articles, and the stay time.

Further, the movement data generation unit 17 can recognize an obstacle present in the above-described area and generate movement data including the presence of the obstacle. In this case, the calculation unit 15 can calculate an index based on the presence of the obstacle. For example, in the case where an obstacle is present on the shortest route, the calculation unit 15 can calculate the above-described index while taking time required to avoid the obstacle into consideration. Further, when the worker performed work to remove the obstacle, the calculation unit 15 can calculate the above-described index while taking time required for this work into consideration.

A more specific example of matching in this example embodiment will be described hereinafter. Picking work in this example embodiment refers to work for taking out articles from, among shelves installed in the above-described area, a shelf designated by the warehouse management system 20, collecting them, and then conveying them to a predetermined position in the above-described area.

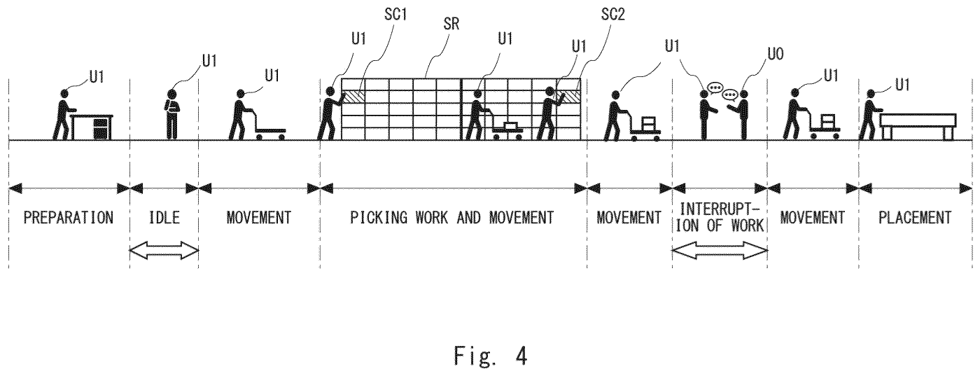

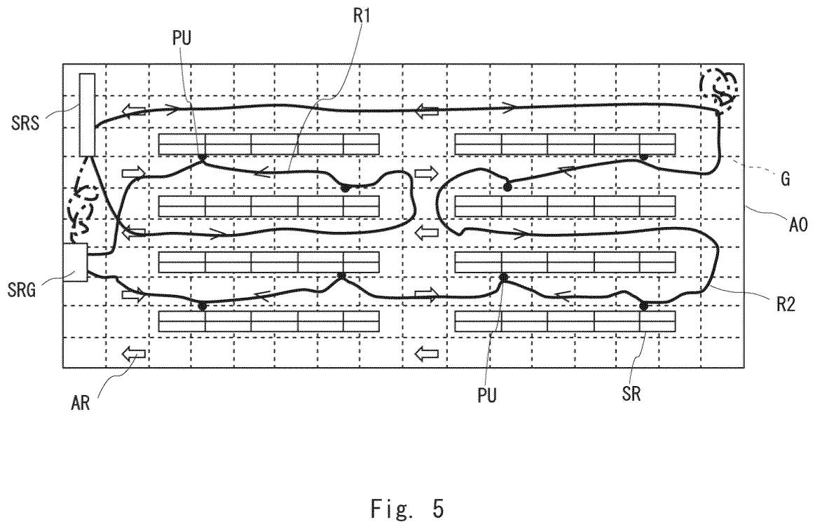

Firstly, an outline of picking work will be described with reference to FIGS. 4 and 5. FIG. 4 is a schematic diagram showing an example of a series of picking operations performed by a worker in this system, and FIG. 5 is a schematic diagram showing an example of a moving route along which the worker moves during the series of picking operations performed by the worker in this system, and is also a schematic diagram showing an example of a displayed moving route.

As shown in FIG. 4, in the picking work performed by the worker U1, after the preparation of the work, the worker U1 moves to a first picking position, possibly spending a waiting time (idle time), and picks one or a plurality of articles while moving. Note that examples of the idle time include time for waiting until a hand truck for conveyance becomes available and time for waiting that occurs because the work area is crowded with other workers. Further, picking can be performed at a position designated by the warehouse management system 20, for example, for articles stored in a picking position SC1 or SC2 in a shelf SR. Further, after the worker U1 has finished picking all the necessary articles, he/she may move and interrupt the work because, for example, he/she talks with another worker U0 or the like. The interruption of the work may also occur in the middle of picking that involves a moving action, or may occur due to the picking position. Lastly, the worker U1 conveys all the picked articles to a predetermined position, i.e., a place to which they should be conveyed, and places them there.

In such picking work, each of a waiting time and a time period during which the work is interrupted, indicated by double-headed outlined arrows in FIG. 4 is a time period during which the worker U1 stays at a certain place and may be a time period unrelated to the work. Therefore, it can be said that the work efficiency is low when there are such time periods. These time periods can be taken into consideration in the calculation of the above-described index as the above-described stay time. Further, the causes of these time periods may also be inferred based on the work data and the movement data. For example, when two workers are close to each other and do not move, it is inferred that their work are interrupted.

In the example shown in FIG. 5, an area A0 in the warehouse is an area to be managed. Further, a desk SRS located at the starting point of picking work, a placement table SRG located at the aforementioned predetermined position at the conveyance destination of picked articles, and a plurality of shelves SR are provided in the area A0. In this example, in the area A0, arrows AR indicating traveling directions are drawn on the floor so that workers do not pass each other in opposing directions. Note that grid lines G shown in the area A0 are grid lines indicating coordinates in the area A0. Although they are shown just for the sake of convenience, white lines or the like representing these grid lines may actually be drawn on the floor or the like. These coordinates can be used as coordinates of positions measured by the 3D sensor 16 and recognized by the movement data generation unit 17.

A plurality of picking lists are placed on the desk SRS so that any worker who becomes available can start work and work is selected according to the importance thereof. Needless to say, the warehouse may be managed without using such picking lists. For example, by having a worker enter information indicating he/she becomes available in the portable terminal 30 or as the warehouse management system 20 detects that the conveyance by the worker has been completed, the warehouse management system 20 can display a picking list on the display unit 31 of the portable terminal 30.

The worker U1 first moves along a route indicated by a route R1 based on a first picking list, picks articles at picking positions PU indicated by black circles (two places in this example), conveys the articles, and places them on the placement table SRG. At the time of the picking, a bar code of an article can be read by the portable terminal 30 to manage whether the article is a correct one. After that, for example, in the case where no picking list is prepared, it becomes an idle time described above with reference to FIG. 4. Next, the worker U1 obtains a second picking list, moves along a route indicated by a route R2 based on the second picking list, picks articles at picking positions PU indicated by black circles (five places in this example), conveys the articles, and places them on the placement table SRG. However, in this example, there is a time period during the worker U1 stays in one place before arriving at the first picking position on the route R2 as indicated by a dash-dot line. This time period corresponds to the time period during which the work is interrupted described above with reference to FIG. 4.

Further, FIG. 5 also shows an example of a displayed moving route of a worker. As shown in this example, the moving route can be displayed together with the area A0 of the warehouse and shelves and desks arranged in the area A0. FIG. 5 shows an example in which the position (route) where the worker stays is indicated by the dash-dot line, but the way of showing such a position is not limited to this example. For example, the position (route) where the worker stays can be indicated in a manner different from that for normal routes, such as displaying such a position in a color different from that for normal routes.

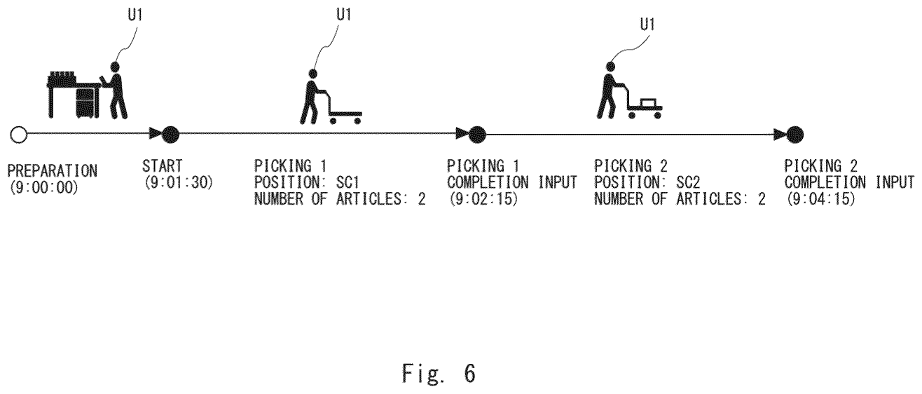

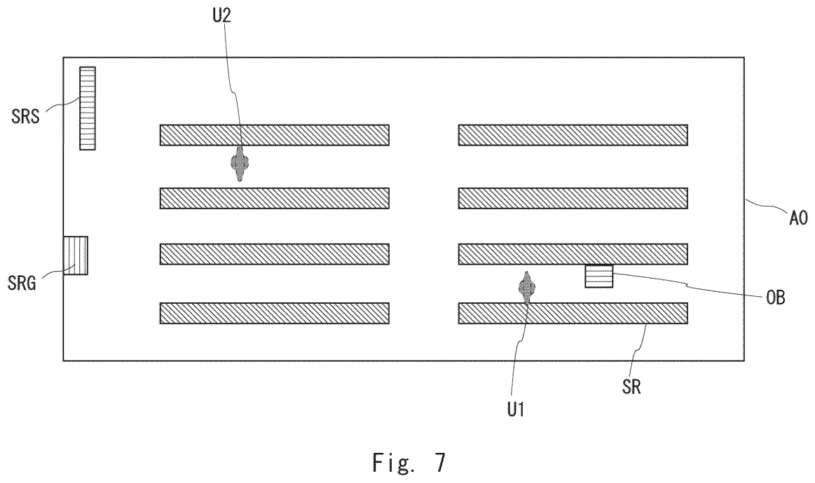

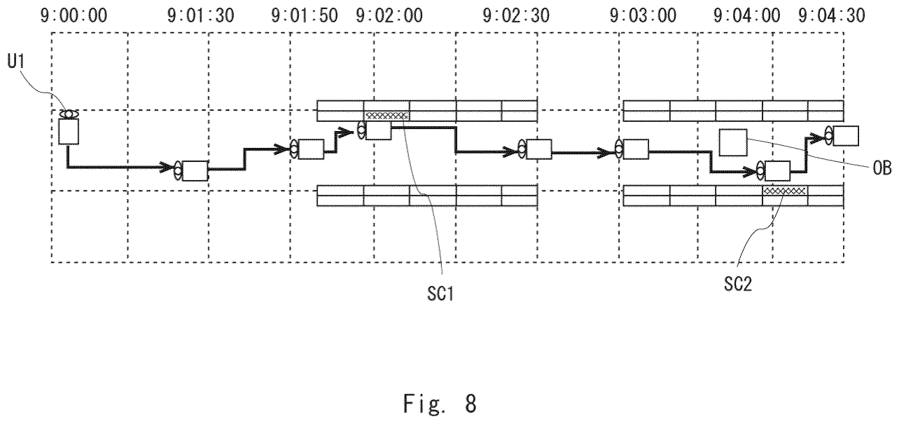

Data obtained during such picking work will be described with reference to FIGS. 6 to 8. FIG. 6 is a schematic diagram for explaining an example of work data acquired in this system. FIG. 7 shows an example of depth data measured by the 3D sensor 16 of the work management system 10. FIG. 8 is a schematic diagram showing an example of movement data generated by the work management system 10.

As shown in FIG. 6, the warehouse management system 20 can record, as work data, time 9:01:30 at a point at which the worker U1 starts moving after the preparation. Information indicating this point is, for example, conveyed to the warehouse management system 20 as the worker U1 enters information indicating the start of work in the portable terminal 30, and a work start point (the position of the desk SRS in this example) is recorded together with the time thereof. The fact that the worker is the worker U1 can be recognized by the fact that he/she is using the portable terminal 30.

Further, after the worker U1 picks two articles at the picking position SC1 where articles to be picked are stored, the worker U1 enters information indicating the completion thereof at time 9:02:15, so that the work content is conveyed to and recorded in the warehouse management system 20 together with the position and the time. Further, after the worker U1 picks two articles at the position SC2 where articles to be picked next are stored, the worker U1 enters information indicating the completion thereof at time 9:04:15, so that the work content is conveyed to and recorded in the warehouse management system 20 together with the position and the time.

As described in this example, work data can include time and a position at which work started, a position at which picking had been performed, and time and a position at which the picking was completed. In the above-described example, there may be a difference between the position at which the completion of the picking is input and the picking position, but this difference is eliminated by adding a temporal error at the time of matching with depth data including time. Further, in order to reduce the error in the picking position, it is possible to obtain information indicating that the worker U1 is present near the shelf where the article is stored by reading a bar code or the like attached to the article by using the portable terminal 30, and to include this position information in the work data.

Further, it is possible to also include, in the work data, data obtained by reading a bar code or the like attached to the shelf or the like by using the portable terminal 30 as the current position of the worker U1. Further, the work data can also include information about the number of picked articles and the types of articles.

FIG. 7 shows depth data at a certain time acquired by the 3D sensor 16. In FIG. 7, for the sake of convenience, parts that are drawn in a dark color, i.e., indicated by hatching, indicate parts that are shallow in depth, and parts that are drawn in white indicate parts that are deepest in depth. In the example shown in FIG. 7, it can be seen that two unidentified persons (in reality, workers U1 and U2) and another obstacle OB, together with the desk SRS, the placement table SRG, and eight shelves SR, can be recognized by the difference in depth. Regarding the obstacle OB, it is possible to determine that the object is the obstacle by the comparison with depth data in places where there is no obstacle.

As shown in FIG. 8, it is possible to recognize the obstacle OB together with the shelves SR from the depth data. Further, when the worker U1 is present, the movement data generation unit 17 can recognize the presence of an arbitrary person from the depth data. Further, since time is included in depth data, the movement data generation unit 17 can generate movement data including times indicating the moving route of the person by analyzing time-series depth data, i.e., by analyzing depth data over the lapse of time.

FIG. 8 shows an example in which results obtained by tracking the person in a time-series manner are plotted. In this example, it can be seen that the person is moving with a rectangular object. This rectangular object is a hand truck, and since a hand truck is often used for work, it is possible to recognize the rectangular object as a hand truck. Further, by linking plotted points as shown in FIG. 8, the movement data generation unit 17 can display them in such a manner that a user or the like can easily recognize the route when he/she views them. Note that although the picking positions SC1 and SC2 are also shown in FIG. 8 for the sake of convenience, these positions cannot be recognized based solely on the depth data. Further, the way of displaying a moving route is not limited to the display form shown in FIG. 8. That is, a moving route can be displayed in various forms such as the above-described display form shown in FIG. 5. By displaying, in addition to the moving route itself, information necessary at the time of the displaying (e.g., the shapes and positions of the desk, shelves, and the like) so that it can be referred to at the time of the displaying, or by storing such necessary information by including it in the moving route data, it is possible to display such information other than the moving route itself together with the moving route.

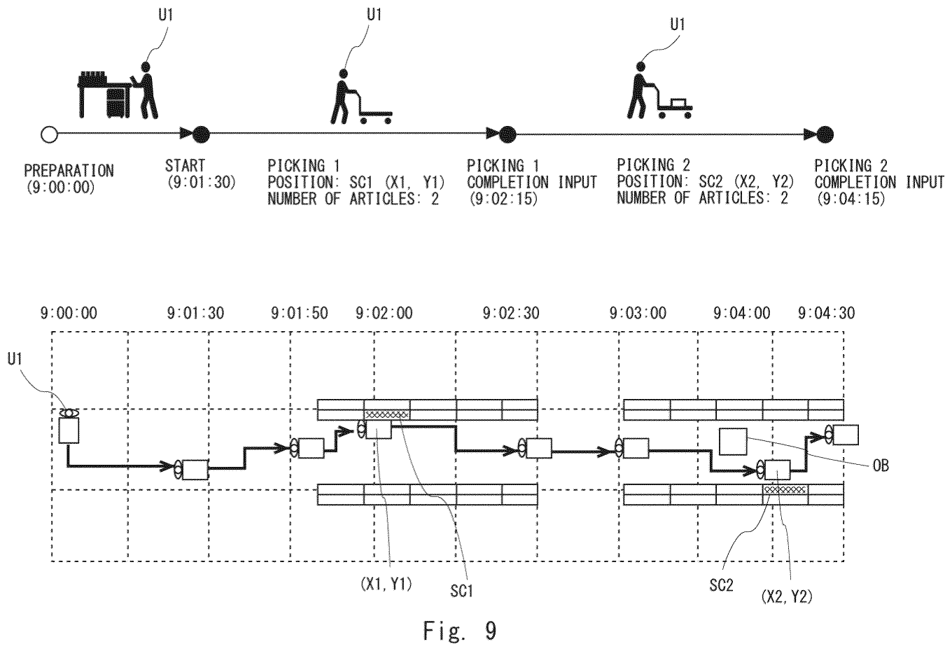

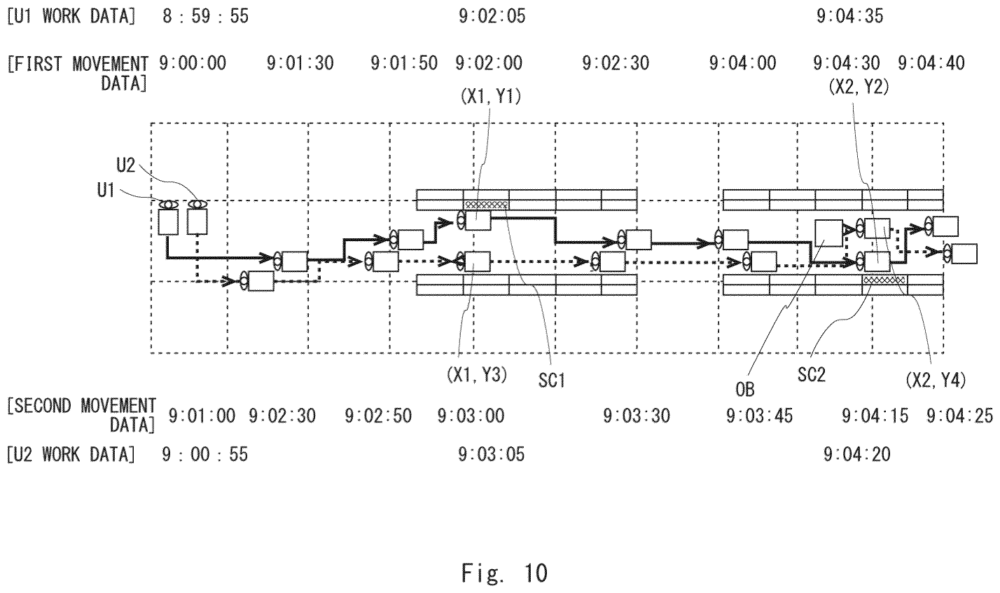

An example in which the work management system 10 matches work data obtained as described above with movement data will be described with reference to FIGS. 9 and 10. FIG. 9 is a schematic diagram showing an example of matching between movement data and work data in the work management system 10, and FIG. 10 is a schematic diagram showing another example of matching between movement data and work data in the work management system 10.

The work data can be input from the warehouse management system 20 by using the input unit 11. As shown in FIG. 9, the identification unit 13 matches, based on the work data and the movement data, the above-described arbitrary person indicated by the movement data with the worker by using the time as a key, and thereby identifies the above-described arbitrary person. In this example, as a result, the arbitrary person is identified as the worker U1.

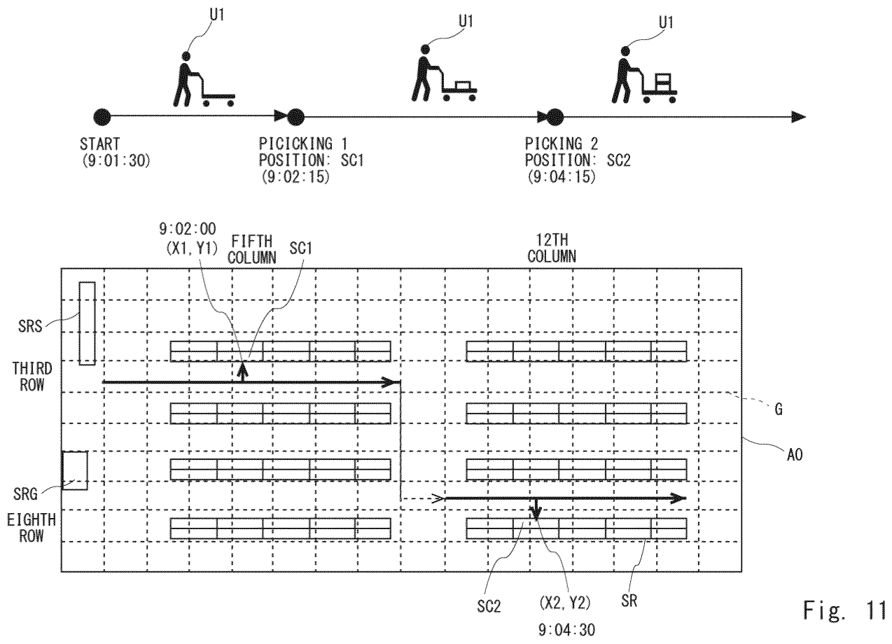

An example of matching will be described in a concrete manner. The work data includes information indicating that the worker U1 has entered, after picking articles at the picking position SC1, completion (i.e., information indicating completion) at time 9:02:15. Meanwhile, the movement data includes information indicating that an arbitrary person is present at coordinates (X1, Y1) at time 9:02:00. The identification unit 13 specifies (i.e., determines) the data of a person who is near the same position on the work data and the movement data as the data of the same worker when a difference between their times is within a predetermined error time range. In this way, it is possible to identify the person who was at the coordinates (X1, Y1) as the worker U1. Note that the predetermined error time may be a constant value, for example, within 20 seconds, or may be a constant value corresponding to the time that is required when a worker or the like present at the picking position exits the area of shelves. Note that in relation to the above-described predetermined error time, an example in which coordinates on work data are matched with those on movement data will be described later with reference to FIG. 11.

Further, the work data also includes information indicating that the worker U1 entered, after picking articles at the picking position SC2, completion at time 9:04:15. Meanwhile, the movement data includes information indicating that an arbitrary person is present at coordinates (X2, Y2) at time 9:04:00. The identification unit 13 specifies (i.e., determines) the data of a person who is near the same position on the work data and the movement data as the data of the same worker when a difference between their times is within a predetermined error time range. In this way, it is possible to identify the person who was at the coordinates (X2, Y2) as the worker U1.

Further, it is conceivable that there is a situation in which a plurality of workers pass the same position in the same time period. An example of processes that are performed in such a situation will be described with reference to FIG. 10. In the following description, an example in which in order to reduce the error in the picking position, information as to which worker is present near the shelf where the article is stored is obtained by reading a bar code or the like attached to the article by using the portable terminal 30, and its position information is included in the work data will be described.

In the example shown in FIG. 10, movement data indicating that workers U1 and U2 are moving along routes indicated by a solid-line arrow and a broken-line arrow, respectively, is generated. The work data of the workers U1 and U2 are shown as U1 work data and U2 work data, respectively, in FIG. 10. Although only times are shown in this example, it is assumed that the fact that the worker works at a position where time is shown is recorded in the respective work data.

In the example shown in FIG. 10, the work data of the worker U1 includes information indicating that the worker U1 performed picking work at the picking position SC1 at time 9:02:05. Further, the work data of the worker U2 includes information indicating that the worker U2 performed picking work at the picking position SC1 at time 9:03:05. Meanwhile, first movement data includes information indicating that an arbitrary person is present at coordinates (X1, Y1) at time 9:02:00, and second movement data includes information indicating that an arbitrary person is present at coordinates (X1, Y3) at time 9:03:00.

In this example, the first movement data is specified as the data of the worker U1, and the second movement data is specified as the data of the worker U2. In this example, since data at time when a bar code or the like of an article is read in picking work is recorded as work data, it is possible to, for example, set the above-described predetermined error time to a shorter time such as 10 seconds, and thereby to improve the matching accuracy. Note that although its description is omitted, the matching in regard to the picking position SC2 can also be performed with an improved accuracy in a similar manner.

Further, by registering the heights of the workers U1 and U2, it is possible to, in some case, distinguish workers from one another by the difference in their heights if there is an enough difference between their heights. Therefore, it may be possible to, by improving the accuracy of the 3D sensor, narrow down candidates of workers by their heights.

An example of a process for matching coordinates on work data and those on movement data will be described hereinafter with reference to FIG. 11. FIG. 11 is a schematic diagram showing an example of a process for matching coordinates on work data and those on movement data in the work management system 10.

The movement data shown in FIG. 11 indicates that an arbitrary person temporarily stays at coordinates (X1, Y1) at time 9:02:20, and after that, the arbitrary person moves, stays at coordinates (X2, Y2) at time 9:04:30, and then moves again. Note that the coordinates (X1, Y1) and (X2, Y2) refer to the third row, fifth column and the eighth row, 12th column of grid G, respectively. Meanwhile, the work data shown in FIG. 11 indicates that the worker U1 is present at a picking completion position close to the picking position SC1 at time 9:02:15 and is present at a picking completion position close to the picking position SC2 at time 9:04:15.

Firstly, when the above-described predetermined error time is set to 20 seconds, which is a long time, and the movement data is matched with the work data based on the time, it can be seen that the coordinates (X1, Y1) and (X2, Y2) correspond to the picking completion positions close to the picking positions SC1 and SC2, respectively. Further, based on the traveling directions indicated by the movement data, it can be seen that the coordinates (X1, Y1) and (X2, Y2) correspond to the picking completion positions after passing the picking positions SC1 and SC2, respectively. Since it takes several seconds from the picking work to the inputting of the picking completion, the coordinates (X1, Y1) and (X2, Y2) can be regarded as the picking positions SC1 and SC2, respectively.

As descried above, according to this example embodiment, it is possible to reduce the number of installed 3D sensors per unit area, associate work data with movement data for a worker, and view or analyze both of these data for the worker. Further, in this example embodiment, by equipping with the calculation unit 15, it becomes possible to recognize efficiency or quantity of work for collecting articles, performed by a worker in a warehouse. Further, it is possible to, by configuring the 3D sensor(s) 16 to detect a person or an obstacle from above the above-described area, it is possible to recognize the above-described efficiency or quantity without installing a large number of detection devices. Further, similarly to the first example embodiment, it is also sufficient if the worker performs work while carrying a terminal used in the warehouse management system in this example embodiment.

### Other Example Embodiments

[a]

In each example embodiment, the work management system, the warehouse management system, and functions of various apparatuses included in these systems have been described. However, these apparatuses are not limited to those shown in the configuration examples. That is, it is sufficient if they can implement these functions as the respective apparatuses.

[b]

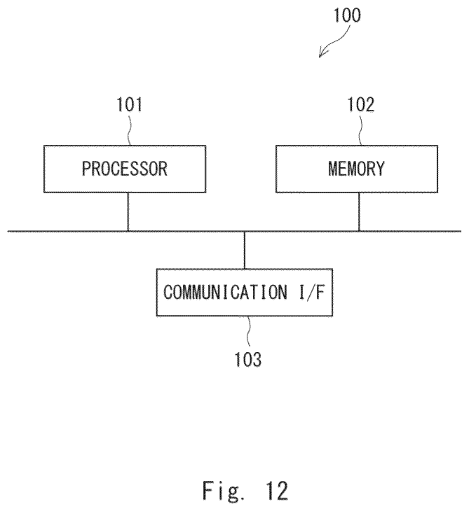

Each of the apparatuses described in the first and second example embodiments may have the following hardware configuration. FIG. 12 shows an example of a hardware configuration of an apparatus. Note that the same applies to the above-described other example embodiments [a].

An apparatus 100 shown in FIG. 12 may include a processor 101, a memory 102, and a communication interface (I/F) 103. The processor 101 may be, for example, a microprocessor, an MPU (Micro Processor Unit), or a CPU. The processor 101 may include a plurality of processors. The memory 102 may be composed of, for example, a combination of a volatile memory and a nonvolatile memory. The functions of the apparatuses described in the first and second example embodiments are implemented by having the processor 101 loading a program(s) stored in the memory 102 and executing the loaded program(s). When doing so, transmission and reception of information to and from other apparatuses can be performed through the communication interface 103 or an input/output interface (not shown).

In the above-described examples, the program includes a set of instructions (or software codes) that, when being loaded into a computer, causes the computer to perform one or more of the functions described in the example embodiments. The program may be stored in a non-transitory computer readable medium or in a physical storage medium. By way of example rather than limitation, a computer readable medium or a physical storage medium may include a random-access memory (RAM), a read-only memory (ROM), a flash memory, a solid-state drive (SSD), or other memory technology, a CD-ROM, a digital versatile disc (DVD), a Blu-ray (registered trademark) disc or other optical disc storages, a magnetic cassette, magnetic tape, and a magnetic disc storage or other magnetic storage devices. The program may be transmitted on a transitory computer readable medium or a communication medium. By way of example rather than limitation, the transitory computer readable medium or the communication medium may include electrical, optical, acoustic, or other forms of propagating signals.

Note that the present disclosure is not limited to the above-described example embodiments and various changes may be made therein without departing from the spirit and scope of the present disclosure. Further, the present disclosure may be implemented by combining example embodiments with one another.

The whole or part of the example embodiments disclosed above can be described as, but not limited to, the following Supplementary notes.

### Supplementary Note 1

A work management system comprising:
an input unit configured to input work data for an area and articles to be managed by a warehouse management system, the work data being data in which, for work for taking out the articles from, among shelves installed in the area, a shelf designated by the warehouse management system, collecting them, and then conveying them to a predetermined position in the area, a work content and a work time for each worker are recorded;
one or a plurality of 3D sensors configured to measure a depth of an object so as to include the area in a measurement range at least during a period during which the work data is recorded, and thereby acquire depth data including time;
a movement data generation unit configured to recognize a position of an arbitrary person and time at the position from the depth data and generate movement data based on a result of the recognition;
an identification unit configured to match, based on the work data input by the input unit and the movement data generated by the movement data generation unit, the arbitrary person indicated by the movement data with the worker by using the time as a key, and thereby identify the arbitrary person; and
an association unit configured to associate the movement data with the work data with respect to the worker identified by the identification unit.

### Supplementary Note 2

The work management system described in Supplementary note 1, further comprising a calculation unit configured to calculate, based on the movement data and the work data with respect to the worker associated by the association unit, an index indicating efficiency or quantity of the work for each worker.

### Supplementary Note 3

The work management system described in Supplementary note 2, wherein
the movement data generation unit generates, based on a position of the arbitrary person and time at the position, moving route data indicating a moving route of the arbitrary person including time as the movement data, and
the calculation unit calculates, based on the movement data and the work data associated with the worker, a stay time during which the worker has stayed in an arbitrary position, and calculates the index based on a predetermined number of articles, a conveyance time required for the conveyance of these articles, and the stay time.

### Supplementary Note 4

The work management system described in Supplementary note 2 or 3, wherein
the movement data generation unit recognizes an obstacle present in the area and generates the movement data including the presence of the obstacle, and
the calculation unit calculates the index based on the presence of the obstacle.

### Supplementary Note 5

The work management system described in any one of Supplementary notes 1 to 4, wherein the work data is data that is input by the worker at a conveyance start time and a conveyance end time of the article in a portable terminal carried by the worker.

### Supplementary Note 6

A work management apparatus comprising:
an input unit configured to input work data for an area and articles to be managed by a warehouse management system, the work data being data in which, for work for taking out the articles from, among shelves installed in the area, a shelf designated by the warehouse management system, collecting them, and then conveying them to a predetermined position in the area, a work content and a work time for each worker are recorded;
one or a plurality of 3D sensors configured to measure a depth of an object so as to include the area in a measurement range at least during a period during which the work data is recorded, and thereby acquire depth data including time;
a movement data generation unit configured to recognize a position of an arbitrary person and time at the position from the depth data and generate movement data based on a result of the recognition;
an identification unit configured to match, based on the work data input by the input unit and the movement data generated by the movement data generation unit, the arbitrary person indicated by the movement data with the worker by using the time as a key, and thereby identify the arbitrary person; and
an association unit configured to associate the movement data with the work data with respect to the worker identified by the identification unit.

### Supplementary Note 7

The work management apparatus described in Supplementary note 6, further comprising a calculation unit configured to calculate, based on the movement data and the work data with respect to the worker associated by the association unit, an index indicating efficiency or quantity of the work for each worker.

### Supplementary Note 8

The work management apparatus described in Supplementary note 7, wherein
the movement data generation unit generates, based on a position of the arbitrary person and time at the position, moving route data indicating a moving route of the arbitrary person including time as the movement data, and
the calculation unit calculates, based on the movement data and the work data associated with the worker, a stay time during which the worker has stayed in an arbitrary position, and calculates the index based on a predetermined number of articles, a conveyance time required for the conveyance of these articles, and the stay time.

### Supplementary Note 9

The work management apparatus described in Supplementary note 7 or 8, wherein
the movement data generation unit recognizes an obstacle present in the area and generates the movement data including the presence of the obstacle, and
the calculation unit calculates the index based on the presence of the obstacle.

### Supplementary Note 10

The work management apparatus described in any one of Supplementary notes 6 to 9, wherein the work data is data that is input by the worker at a conveyance start time and a conveyance end time of the article in a portable terminal carried by the worker.

### Supplementary Note 11

A work management method comprising:
inputting work data for an area and articles to be managed by a warehouse management system, the work data being data in which, for work for taking out the articles from, among shelves installed in the area, a shelf designated by the warehouse management system, collecting them, and then conveying them to a predetermined position in the area, a work content and a work time for each worker are recorded;
measuring a depth of an object so as to include the area in a measurement range at least during a period during which the work data is recorded, and thereby acquiring depth data including time;
recognizing a position of an arbitrary person and time at the position from the depth data and generating movement data based on a result of the recognition;
matching, based on the input work data and the generated movement data, the arbitrary person indicated by the movement data with the worker by using the time as a key, and thereby identifying the arbitrary person; and
associating the movement data with the work data with respect to the identified worker.

### Supplementary Note 12

The work management method described in Supplementary note 11, wherein an index indicating efficiency or quantity of the work for each worker is calculated based on the movement data and the work data with respect to the associated worker.

### Supplementary Note 13

The work management method described in Supplementary note 12, wherein
the generating the movement data includes generating, based on a position of the recognized arbitrary person and time at the position, moving route data indicating a moving route of the arbitrary person including time as the movement data, and
the calculating the index includes calculating, based on the movement data and the work data associated with the worker, a stay time during which the worker has stayed in an arbitrary position, and calculating the index based on a predetermined number of articles, a conveyance time required for the conveyance of these articles, and the stay time.

### Supplementary Note 14

The work management method described in Supplementary note 12 or 13, wherein
the generating the movement data includes recognizing an obstacle present in the area and generating the movement data including the presence of the obstacle, and
the calculating the index includes calculating the index based on the presence of the obstacle.

### Supplementary Note 15

The work management method described in any one of Supplementary notes 11 to 14, wherein the work data is data that is input by the worker at a conveyance start time and a conveyance end time of the article in a portable terminal carried by the worker.

### Supplementary Note 16

A non-transitory computer readable medium storing a program for causing a computer to perform a work management process including:
inputting work data for an area and articles to be managed by a warehouse management system, the work data being data in which, for work for taking out the articles from, among shelves installed in the area, a shelf designated by the warehouse management system, collecting them, and then conveying them to a predetermined position in the area, a work content and a work time for each worker are recorded;
measuring a depth of an object so as to include the area in a measurement range at least during a period during which the work data is recorded, and thereby acquiring depth data including time;
recognizing a position of an arbitrary person and time at the position from the depth data and generating movement data based on a result of the recognition;
matching, based on the input work data and the generated movement data, the arbitrary person indicated by the movement data with the worker by using the time as a key, and thereby identifying the arbitrary person; and
associating the movement data with the work data with respect to the identified worker

### Supplementary Note 17

The non-transitory computer readable medium described in Supplementary note 16, wherein the work management process includes calculating an index indicating efficiency or quantity of the work for each worker based on the movement data and the work data with respect to the associated worker.

### Supplementary Note 18

The non-transitory computer readable medium described in Supplementary note 17, wherein
the generating the movement data includes generating, based on a position of the recognized arbitrary person and time at the position, moving route data indicating a moving route of the arbitrary person including time as the movement data, and
the calculating the index includes calculating, based on the movement data and the work data associated with the worker, a stay time during which the worker has stayed in an arbitrary position, and calculating the index based on a predetermined number of articles, a conveyance time required for the conveyance of these articles, and the stay time.

### Supplementary Note 19

The non-transitory computer readable medium described in Supplementary note 17 or 18, wherein
the generating the movement data includes recognizing an obstacle present in the area and generating the movement data including the presence of the obstacle, and
the calculating the index includes calculating the index based on the presence of the obstacle.

### Supplementary Note 20

The non-transitory computer readable medium described in any one of Supplementary notes 16 to 19, wherein the work data is data that is input by the worker at a conveyance start time and a conveyance end time of the article in a portable terminal carried by the worker.

Although the present invention is described above with reference to example embodiments, the present invention is not limited to the above-described example embodiments.

Various modifications that can be understood by those skilled in the art can be made to the configuration and details of the present invention within the scope and spirit of the invention.

### REFERENCE SIGNS LIST

1, 10 WORK MANAGEMENT SYSTEM
1a, 11 INPUT UNIT
1ba, 16 3D SENSOR
1bb, 17 MOVEMENT DATA GENERATION UNIT
1c, 13 IDENTIFICATION UNIT
1d, 14 ASSOCIATION UNIT
12 MEASUREMENT UNIT
15 CALCULATION UNIT
20 WAREHOUSE MANAGEMENT SYSTEM
21 CONTROL UNIT
22 STORAGE UNIT
23 OUTPUT UNIT
30 PORTABLE TERMINAL
31 DISPLAY UNIT
32 OPERATION BUTTON
100 APPARATUS
101 PROCESSOR
102 MEMORY
103 COMMUNICATION INTERFACE

What is claimed is:

1. A work management system comprising:
one or a plurality of 3D sensors;
at least one memory storing instructions; and
at least one processor configured to execute the instructions to do work management process, wherein the work management process includes:
inputting work data for an area and articles to be managed by a warehouse management system, the work data being data in which, for work for taking out the articles from, among shelves installed in the area, a shelf designated by the warehouse management system, collecting them, and then conveying them to a predetermined position in the area, a work content and a work time for each worker are recorded;
making the one or a plurality of 3D sensors to measure a depth of an object so as to include the area in a measurement range at least during a period during which the work data is recorded, and thereby acquiring depth data including time;
recognizing a position of an arbitrary person and time at the position from the depth data and generating movement data based on a result of the recognition;
matching, based on the input work data and the generated movement data, the arbitrary person indicated by the movement data with the worker by using the time as a key, and thereby identifying the arbitrary person; and
associating the movement data with the work data with respect to the identified worker.

2. The work management system according to claim 1, wherein the work management process further includes calculating, based on the movement data and the work data with respect to the associated worker, an index indicating efficiency or quantity of the work for each worker.

3. The work management system according to claim 2, wherein
the generating the movement data includes generating, based on a position of the recognized arbitrary person and time at the position, moving route data indicating a moving route of the arbitrary person including time as the movement data, and
the calculating the index includes calculating, based on the movement data and the work data associated with the worker, a stay time during which the worker has stayed in an arbitrary position, and calculating the index based on a predetermined number of articles, a conveyance time required for the conveyance of these articles, and the stay time.

4. The work management system according to claim 2, wherein
the generating the movement data includes recognizing an obstacle present in the area and generating the movement data including the presence of the obstacle, and
the calculating the index includes calculating the index based on the presence of the obstacle.

5. The work management system according to claim 1, wherein the work data is data that is input by the worker at a conveyance start time and a conveyance end time of the article in a portable terminal carried by the worker.

6. (canceled)

7. (canceled)

8. (canceled)

9. (canceled)

10. (canceled)

11. A work management method comprising:
inputting work data for an area and articles to be managed by a warehouse management system, the work data being data in which, for work for taking out the articles from, among shelves installed in the area, a shelf designated by the warehouse management system, collecting them, and then conveying them to a predetermined position in the area, a work content and a work time for each worker are recorded;
measuring a depth of an object so as to include the area in a measurement range at least during a period during which the work data is recorded, and thereby acquiring depth data including time;
recognizing a position of an arbitrary person and time at the position from the depth data and generating movement data based on a result of the recognition;
matching, based on the input work data and the generated movement data, the arbitrary person indicated by the movement data with the worker by using the time as a key, and thereby identifying the arbitrary person; and
associating the movement data with the work data with respect to the identified worker.

12. The work management method according to claim 11, wherein an index indicating efficiency or quantity of the work for each worker is calculated based on the movement data and the work data with respect to the associated worker.

13. The work management method according to claim 12, wherein
the generating the movement data includes generating, based on a position of the recognized arbitrary person and time at the position, moving route data indicating a moving route of the arbitrary person including time as the movement data, and
the calculating the index includes calculating, based on the movement data and the work data associated with the worker, a stay time during which the worker has stayed in an arbitrary position, and calculating the index based on a predetermined number of articles, a conveyance time required for the conveyance of these articles, and the stay time.

14. The work management method according to claim 12, wherein
the generating the movement data includes recognizing an obstacle present in the area and generating the movement data including the presence of the obstacle, and
the calculating the index includes calculating the index based on the presence of the obstacle.

15. The work management method according to claim 11, wherein the work data is data that is input by the worker at a conveyance start time and a conveyance end time of the article in a portable terminal carried by the worker.

16. A non-transitory computer readable medium storing a program for causing a computer to perform a work management process including:
inputting work data for an area and articles to be managed by a warehouse management system, the work data being data in which, for work for taking out the articles from, among shelves installed in the area, a shelf designated by the warehouse management system, collecting them, and then conveying them to a predetermined position in the area, a work content and a work time for each worker are recorded;
measuring a depth of an object so as to include the area in a measurement range at least during a period during which the work data is recorded, and thereby acquiring depth data including time;
recognizing a position of an arbitrary person and time at the position from the depth data and generating movement data based on a result of the recognition;
matching, based on the input work data and the generated movement data, the arbitrary person indicated by the movement data with the worker by using the time as a key, and thereby identifying the arbitrary person; and
associating the movement data with the work data with respect to the identified worker.

17. The non-transitory computer readable medium according to claim 16, wherein the work management process includes calculating an index indicating efficiency or quantity of the work for each worker based on the movement data and the work data with respect to the associated worker.

18. The non-transitory computer readable medium according to claim 17, wherein
the generating the movement data includes generating, based on a position of the recognized arbitrary person and time at the position, moving route data indicating a moving route of the arbitrary person including time as the movement data, and
the calculating the index includes calculating, based on the movement data and the work data associated with the worker, a stay time during which the worker has stayed in an arbitrary position, and calculating the index based on a predetermined number of articles, a conveyance time required for the conveyance of these articles, and the stay time.

19. The non-transitory computer readable medium according to claim 17, wherein
the generating the movement data includes recognizing an obstacle present in the area and generating the movement data including the presence of the obstacle, and
the calculating the index includes calculating the index based on the presence of the obstacle.

20. The non-transitory computer readable medium according to claim 16, wherein the work data is data that is input by the worker at a conveyance start time and a conveyance end time of the article in a portable terminal carried by the worker.
